(19) United States
(12) Patent Application Publication
(10) Pub. No.: US 2007/0166833 A1
(43) Pub. Date: Jul. 19, 2007

(54) Sample preparation method including cooling and cutting

(76) Inventors: Gordon Shanthakumar Rajendram, Hamilton (NZ); Geordie Robert Burling-Claridge, Hamilton (NZ)

Correspondence Address: KNOBBE MARTENS OLSON & BEAR LLP, 2040 MAIN STREET, FOURTEENTH FLOOR, IRVINE, CA, 92614, US

(21) Appl. No.: 10/521,027

(22) PCT Filed: Jul. 9, 2003
(86) PCT No.: PCT/NZ03/00147

§ 371 Date: Nov. 18, 2005

(30) Foreign Application Priority Data
Jul. 12, 2002 (NZ) 520125

(51) Int. Cl. G01N 1/10

(52) U.S. Cl. 436/174

(57) ABSTRACT

The present invention relates to the provision of a compound preparation method and apparatus which can be used to prepare a compound or sample for a further analytical or reactive process. Preferably the present invention may be adapted to cool the compound in question to increase its rigidity and to subsequently allow for the mechanical processing of the compound to render it into a plurality of particles or components of substantially the same size.

### TECHNICAL FIELD

This invention relates to a method of preparing a compound. Preferably the compound involved may be prepared for subsequent analysis of its components. However, in other embodiments, such compounds may be prepared with a view to providing a reactant for other processes. The present invention may preferably allow a compound to be rendered into a plurality of substantially homogenous sized particles.

### BACKGROUND ART

Some types of chemical analysis equipment require a sample for analysis to be supplied as a number of substantially homogenous particles. Furthermore, some types of chemical reactions can also require one of the reactant compounds involved again to be supplied as a plurality of particles of substantially the same size.

An existing technique used to prepare such samples or compounds employs a grinding procedure. If the compound involved is wet or composed of organic tissue, it will need to be thoroughly dried prior to grinding. Drying the sample prior to breaking it up ensures that it can be ground effectively from a large component element. The drying process involved can take some time as the sample is made up of relatively large component portions.

The need to grind thoroughly and also dry such compounds makes the preparation method employed relatively slow. Having to both dry and also grind a compound is both slow and relatively laborious work.

Furthermore, as the compound preparation time increases, so do the chances of the compound being exposed to some form of contaminant, or alternatively degrading with age.

This type of preparation work normally must also be completed within a laboratory environment. This again puts some limitations on the utility of such preparation methods, which cannot be employed out in the field where (for example) a sample has been freshly collected.

One application where an improved method of compound preparation would provide advantages is in the use of near infra-red (NIR) spectrophotometers. These devices can detect the presence and also the concentration of a wide range of analytes or compounds within a properly prepared sample. In addition, the analytes, which can be targeted by NIR spectrophotometers, encompass a wide range of compounds present in organic tissues, and as such, a preparation method which could quickly prepare an organic sample for analysis would be of advantage.

An improved method of preparing a compound which addressed any or all of the above issues would be of advantage. A method which could render a compound into a plurality of substantially homogenous size particles quickly without the need for expensive or complicated equipment, or a laboratory environment, would be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a compound preparation method characterised by the steps of:
(i) cooling the compound to increase its rigidity, and
(ii) mechanically processing the compound to render the compound into a plurality of particles or components of substantially the same size.

According to a further aspect of the present invention there is provided a compound preparation method characterised by the steps of:
(i) cooling the compound to increase its rigidity, and
(ii) mechanically processing the compound to render same into a plurality of particles or components of substantially the same size, and
(iii) subjecting the rendered compound to an analysis and/or reaction process.

According to a further aspect of the present invention there is provided a method of preparing a compound substantially as described above, wherein a compound is prepared to provide a sample for an analysis procedure.

According to yet another aspect of the present invention there is provided a method of preparing a compound substantially as described above, wherein the compound is cooled with liquid carbon dioxide.

According to a further aspect of the present invention there is provided a method of preparing a compound substantially as described above, wherein the compound is mechanically processed by at least one rotating blade.

According to yet another aspect of the present invention there is provided a compound preparation method substantially as described above, wherein the rendered or processed compound is analysed using a near infra-red spectrophotometer.

According to yet another aspect of the present invention there is provided a compound preparation method substantially as described above wherein the compound is composed of or formed from plant tissue.

According to a further aspect of the present invention there is provided a compound preparation apparatus which includes a cooling means adapted to cool the compound to increase its rigidity, and a mechanical processing means adapted to mechanically process a compound to render the compound into a plurality of components of substantially the same size.

The present invention relates to an improved method of preparing a compound. Any number and range of different types of compounds may be prepared using the present invention depending on the particular application which it is employed within. However, it is envisioned that the preparation method discussed below could primarily be used to prepare a small volume or weight of compounds or samples.

Those skilled in the art should appreciate that after preparation the compound involved may be subjected to various further processing, analysis or reactions depending on the application which the present invention is used within.

Reference throughout this specification will also be made to the present invention being used to provide a sample preparation method where the sample involved is to be analysed to investigate its constituent components. The present invention may provide a preparation method which can allow a sample compound to be rendered into a plurality of distinct particles that are substantially the same size. However, those skilled in the art should appreciate that other applications are also envisioned for the present invention and reference to the above only throughout this specification should in no way be seen as limiting. For example, in one alternative embodiment, the present invention may be used to prepare a compound to be reacted with other materials.

In a further preferred embodiment the compound to be prepared may be organic in nature, such as plant or animal tissue. Organic materials normally contain a high moisture content, and as such sample preparation time is relatively long using prior art preparation methods. However, through use of the present invention the time required to prepare such samples can be substantially reduced.

Reference throughout this specification will also be made to a sample prepared in accordance with the present invention being plant tissue. However, those skilled in the art should appreciate that other types of compounds or organic materials may also be prepared using the present invention, and reference to the above only throughout this specification should in no way be seen as limiting.

In a preferred embodiment the present invention may be used to prepare a sample for analysis by a near infra-red spectrophotometer. Near infra-red (NIR) spectrophotometers can detect the presence and also concentration of a wide variety of analytes, including those commonly found and of interest within organic materials such as plant tissue.

Preferably the first step employed in the method of the present invention is to cool the sample or compound to be prepared, thereby increasing its physical rigidity. The temperature of the compound may be lowered significantly, which in some instances will freeze the compound solid.

In a further preferred embodiment a sample may be exposed to a cooling agent to achieve the cooling effect required. Such a cooling agent may be a further compound which can be intimately exposed to a sample to cool same. Preferably a cooling means may be provided to facilitate or execute this operation.

For example, in a preferred embodiment a cooling means, agent or material may be provided through the use of liquefied carbon dioxide. A sample may be dipped or immersed in liquefied carbon dioxide to rapidly reduce its temperature and therefore substantially increase its physical rigidity. The time required for the cooling to be completed is relatively short with liquefied carbon dioxide, therefore providing a relatively short sample preparation time.

However, in alternative embodiments other means for cooling a sample may be employed. For example, in one alternative embodiment a sample may be immersed or dipped into liquid nitrogen, again to provide the cooling effect required. In yet another alternative embodiment a sample may be cooled using freeze drying equipment to again quickly reduce the temperature and increase the rigidity of the compound or sample.

Reference throughout this specification will however be made to a sample initially being cooled through immersion in liquefied carbon dioxide. However, those skilled in the art should appreciate that other types of cooling agents or equipment may also be employed and reference to the above only throughout this specification should in no way be seen as limiting.

Preferably after a sample has been cooled and its physical rigidity increased, it may then be subjected to a mechanical processing step. This mechanical processing can be used to render the sample into a plurality of particles or components which have substantially the same size. This in effect will homogenise the sample rendering it into a collection of particles or component pieces with a substantially uniform nature. The actual end product or final form of the rendered sample will be determined by the degree of mechanical processing employed in addition to the moisture content of the sample. Preferably a mechanical processing means may be used to facilitate or execute the operation required.

In a further preferred embodiment a mechanical processing means may include a rotating blade. The cooled sample or compound may be placed within a container which also houses a blade adapted to be driven in a circular motion. When activated, the blade will make a large number of cuts through the material of the sample which has been temporarily stiffened through the cooling step discussed above. The rotating blade employed can then shatter the relatively rigid sample to render same into a plurality of particles or portions of substantially the same size. Varying sizes of samples or compounds may also be processed depending on the capacity of the equipment used.

In a preferred embodiment, the mechanical processing means may be provided with a housing within which the compound to be processed is retained during use.

In a further preferred embodiment, the processing means housing may be substantially conical in shape with the active components used to cut, grind, pulverise or otherwise mechanically process the compound in question being located substantially at the bottom of this conical shaped housing. The use of this particular shape or type of housing ensures that any parts of the compound being process which are thrown upwards during the processing operation will be encouraged to fall directly back down into the active components of the processing means.

Reference throughout this specification will also be made to a sample or compound being mechanically processed through use of a rotating blade substantially as described above. However, those skilled in the art should appreciate that other types of mechanical processing systems may also be employed and reference to the above only throughout this specification should in no way be seen as limiting.

For example, in one alternative embodiment a mechanical processing means may be provided through a system or apparatus adapted to grind or pulverise a compound. In such an embodiment one or more grinding plates or weights may move over a surface with the compound to be processed trapped between same.

In a preferred embodiment the housing of the mechanical processing means may also be reinforced to withstand forces applied by relatively high pressure air, fluids or gases employed in conjunction with the present invention. For example, in one preferred embodiment the mechanical processing means housing may be reinforced to withstand pressures of up to 1.5 atmospheres to allow high pressure or high velocity fluids or gases to be introduced into the interior of the processing means if required.

In a preferred embodiment, the mechanical processing means may include one, two or more sets of pairs of opposed blades orientated substantially horizontally with respect to the housing of the processing means. One, two or more sets of opposed blade pairs may also be located on a central drive axis or axle adapted to rotate these blades when the processing means is used.

In a further preferred embodiment, the processing means may include two pairs of opposed blades, with only one pair disposed directly above the other. This combination of four distinct blades may be drive by a single common drive shaft to rotate in a substantially horizontal plane within the interior of the processing means housing.

Reference throughout this specification will also be made to the processing means including two paired sets of opposed blades substantially as described above. However, those skilled in the art should appreciate that other configurations of the processing means are envisioned and reference to the above only throughout this specification should in no way be seen as limiting.

In one further preferred embodiment of the present invention the processing means may also include a grinding mechanism in addition to one, two or more rotating blades. In such an embodiment a grinding mechanism may be located substantially within the base of the processing means housing so that once a compound has been rendered into a number of relatively small components, these components will in turn fall into the grinding means to be rendered into yet smaller components or particles. For example, in one embodiment a grinding means may be formed from a flat base to the housing in addition to a rotating semicircular weight which is disposed below a mesh grating or screen. Only particles or material of a size smaller than the apertures in the grating will be capable of falling into the interior of the grinding means and thereby be pulverised or ground further.

In a further preferred embodiment, the present invention may also include a flushing means. A flushing means may be adapted to flush out gas present within the mechanical processing means after a sample has been effectively homogenised and processed. The case of a preferred embodiment where a source of liquefied carbon dioxide is employed as a cooling means, the flushing means may be used to remove excess carbon dioxide from within the processing means and thereby ready the processed sample or compound for presentation to a further process or reaction.

In a further preferred embodiment, a flushing means may consist of or include a fan and/or a heating element. A fan may be employed to force pressurised atmospheric air into the interior of the processing means thereby flush excess carbon dioxide out from this region. Furthermore, the flushing means may also incorporate a heater element which can heat air driven into the interior of the processing means. Heated air will again heat the sample or compound further and liberate additional carbon dioxide from the interior of the processing means.

In a further preferred embodiment, the flushing means may also be used in some instances to further dry the compound or sample present within the processing means after homogenisation. The application of heated air into this region can be used to further dry an originally ‘wet’ sample if required depending on the next analytical process involved. In such instances, a stream of heated air may be supplied from the flushing means over a period of several minutes to dry the material of the processing means if required.

The present invention may provide many potential advantages over the prior art.

The combination of a cooling phase and mechanical processing phase allows a sample to be rendered into a plurality of substantially homogenous small particles which contain essentially the same moisture content as the sample at the start of the processing method. The moisture content already present within the sample allows analytes of interest to in effect remain “in solution”, ready for presentation to the NIR spectrophotometer or other similar instrument.

Eliminating the need for drying further simplifies and speeds up the sample or compound preparation method provided. After mechanical rendering has been completed, a sample may then be directly presented to a spectrophotometer.

The present invention may also be used to quickly, easily and inexpensively prepare numerous different types of compounds for subsequent analysis or further reactions with other compounds. The present invention can be used to break up a compound into a large number of small, even or homogenous particles relatively quickly for use in a large number of applications.

Furthermore, the equipment or apparatus employed in conjunction with the present invention is readily portable and can be used in the field at sample or compound collection sites, to immediately prepare a sample for further analysis or reaction. This reduces the chances of the sample becoming contaminated through long periods of storage or handling and also reduces the chances of the sample degrading over time.

The use of liquefied carbon dioxide in preferred embodiments also allows a sample or compound to be cooled rapidly and effectively. Liquefied carbon dioxide is a relatively inexpensive cooling material and is safer for operators to handle than liquid nitrogen at lower temperatures. Furthermore, the use of carbon dioxide is preferable where a sample to be prepared is to be analysed for its nitrogen content. In addition, carbon dioxide being higher temperature than liquid nitrogen will extend the lifespan of the equipment used in conjunction with the present invention. As the carbon dioxide employed is of a higher temperature, it degrades the equipment used slower than liquid nitrogen.

The provision in some embodiments of a flushing means can also allow excess carbon dioxide or other types of cooling agents to be flushed from the interior of the processing means employed. Furthermore, the provision of a source of heat within such a flushing means also allows the homogenised sample or compound to be dried easily and quickly when preferably in a particulate form.

### BRIEF DESCRIPTION OF DRAWINGS

Further aspects of the present invention will become apparent from the following description which is given by way of example only and with reference to the accompanying drawings in which:

FIG. 1 illustrates a block schematic diagram of the processes executed by a method of preparation in accordance with a preferred embodiment of the present invention;

FIG. 2 illustrates a block schematic diagram of apparatus and components employed to provide a compound processing apparatus in accordance with an alternative embodiment of the present invention.

### BEST MODES FOR CARRYING OUT THE INVENTION

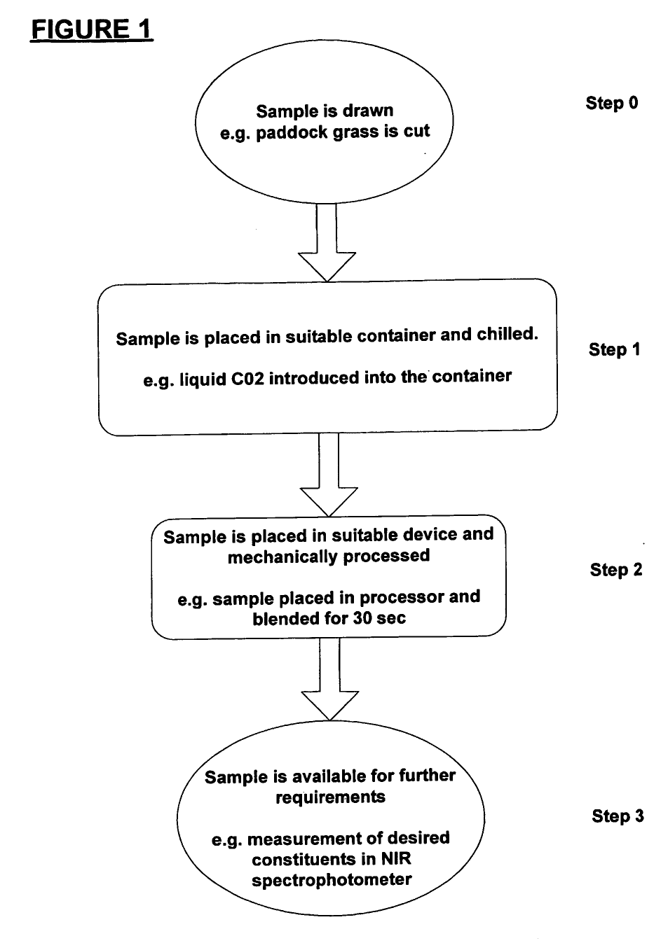

FIG. 1 illustrates a block schematic diagram of the steps executed in a method of preparation provided in accordance with a preferred embodiment.

In the instance discussed, the present invention is adapted to prepare a plant tissue sample for subsequent analysis by a near infra-red spectrophotometer.

The sample to be prepared is initially drawn in Step 0. For example, in a preferred instance a grass sample is cut from a paddock to provide the sample required.

In the schematic diagram shown, Step 1 is implemented to cool the sample provided and therefore increase its rigidity. Preferably this step is executed through immersing the sample in a container of liquefied carbon dioxide. This will snap-freeze the vegetative sample, substantially increasing the rigidity of the vegetative material, while also preserving the moisture content present within the vegetation.

After the sample has been retrieved from the carbon dioxide it is then presented to a mechanical processing means at Step 2 of the methodology executed. The processing means with an associated set of rotating blades can be used to cut up and mechanically render the snap frozen vegetative sample into a plurality of distinct and substantially homogenised particles. A large number of relatively small particles of substantially the same size may be provided through this action. The increased rigidity of the frozen vegetation allows the rotating blades to shatter and cut the vegetation into a collection of small particles.

Once the cooling and subsequent mechanical processing Steps 1 and 2 are completed, the processed sample can be presented to a NIR spectrophotometer at Step 3. The sample can be directly presented to the spectrophotometer after mechanical processing Step 2. Through preserving the moisture content of the sample during the processing method executed, analytes of interest remain free for a spectrophotometer to detect same without a solvent being applied or used.

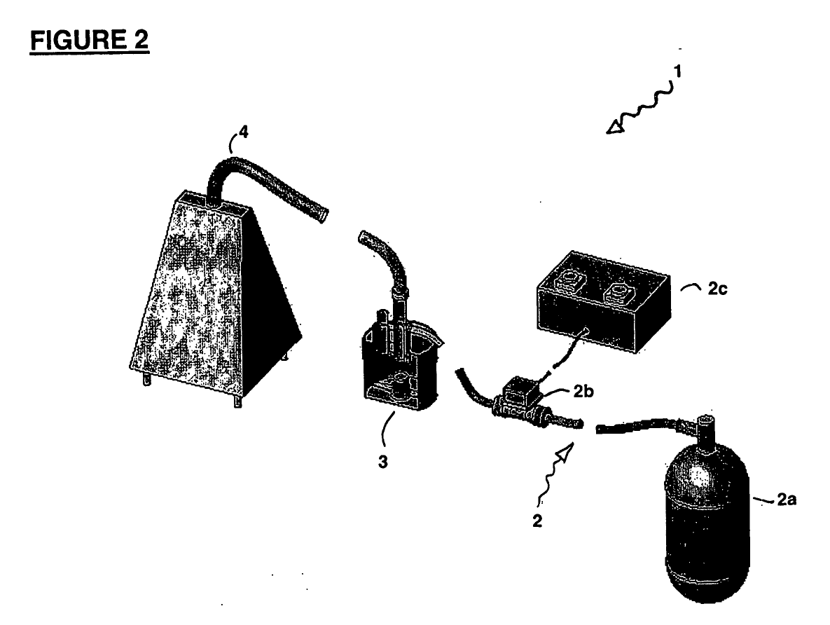

FIG. 2 shows a compound preparation apparatus (1) as configured in accordance with an alternative embodiment of the present invention to that discussed with respect to FIG. 1. The apparatus (1) includes a cooling means (2), composed in the embodiment shown from a bottle of liquefied carbon dioxide (2a) linked to a supply line and solenoid valve (2b). The operation of the solenoid valve is controlled in turn by a control box (2c) which includes a number of user operable switches.

The cooling means (2) is adapted to supply liquefied carbon dioxide on demand into the interior of a mechanical processing means (3), shown in this embodiment as being provided with a pair of rotating blades.

The compound or sample to be processed is first placed within the interior of the processing means. Initially a stream of liquefied carbon dioxide is supplied from the cooling means to immerse the sample and subsequently increase its rigidity. After the sample has been immersed and frozen, the blades of the processing means are rotated to shatter and chop the sample into a large number of relatively small homogenous particles.

At this stage, the last component shown, being a flushing means (4) is activated. The flushing means includes a fan based component and an associated heater (not shown) both of which are adapted to supply heated air into the interior of the processing means (3). This heated air will drive excess carbon dioxide out of the sample and potentially also dry the now homogenised particular sample compound. Aspects of the present invention have been described by way of example only and it should be appreciated that modifications and additions may be made thereto without departing from the scope thereof as defined in the appended claims.

1-20. (canceled)

21. A compound preparation method characterized by the steps of:
cooling the compound to increase its rigidity, and
mechanically processing the compound to render the compound into a plurality of particles or components of substantially the same size.

22. A compound preparation method as claimed in claim 21, further characterized by the additional subsequent step of:
subjecting the rendered compound to an analysis and/or reaction process.

23. A compound preparation method as claimed in claim 22, wherein the compound is prepared prior to an analysis process used to investigate the compound's constituent components.

24. A compound preparation method as claimed in claim 23 wherein the compound is analyzed using a near infra-red spectrophotometer.

25. A compound preparation method as claimed in claim 21 wherein the compound is cooled using a cooling agent.

26. A compound preparation method as claimed in claim 25 wherein the compound is immersed in the cooling agent to cool the compound and increase the compound's rigidity.

27. A compound preparation method as claimed in claim 21 wherein the compound is cooled using liquid carbon dioxide.

28. A compound preparation method as claimed in claim 21 wherein mechanical processing of the compound homogenizes the compound.

29. A compound preparation method as claimed in claim 21 wherein the mechanical processing of the compound renders the compound into a plurality of distinct particles of substantially the same size.

30. A compound preparation method as claimed in claim 21 wherein the compound is mechanically processed using at least one rotating blade.

31. A compound preparation method as claimed in claim 21 wherein the compound is an organic compound.

32. A compound preparation method as claimed in claim 31 wherein the compound is formed from or includes plant tissue.

33. A compound preparation apparatus which includes a cooling means adapted to cool the compound to increase the compound's rigidity, and a mechanical processing means adapted to mechanically process the compound to render the compound into a plurality of components of substantially the same size.

34. A compound preparation apparatus as claimed in claim 33 wherein the cooling means is adapted to supply a cooling agent to cool the compound and increase the compound's rigidity.

35. A compound preparation apparatus as claimed in claim 34 wherein the cooling means includes a source of liquefied carbon dioxide.

36. A compound preparation apparatus as claimed in claim 33 wherein the mechanical processing means includes at least one blade adapted to rotate to mechanically process a compound.

37. A compound preparation apparatus as claimed in claim 33 which includes a flushing means adapted to flush gas from within the mechanical processing means.

38. A compound preparation apparatus as claimed in claim 37 wherein the flushing means includes at least one fan and/or heating element combination.
